(19) United States
(12) Patent Application Publication
(10) Pub. No.: US 2011/0302969 A1
(43) Pub. Date: Dec. 15, 2011

(54) KEY CYLINDER INSTALLATION STRUCTURE

(75) Inventor: Jun MIZUMOTO, Aichi (JP)

(73) Assignee: KABUSHIKI KAISHA TOKAI RIKA DENKI SEISAKUSHO, Aichi (JP)

(21) Appl. No.: 13/153,645

(22) Filed: Jun. 6, 2011

(30) Foreign Application Priority Data
Jun. 10, 2010 (JP) 2010-133010

(51) Int. Cl. E05B 9/04

(52) U.S. Cl. 70/449

(57) ABSTRACT

A key cylinder installation structure includes a key cylinder including a flange that is fixed to a trunk of a vehicle, the flange including a mounting hole through which a mounting bolt is inserted into a reference hole and a secondary reference hole, respectively, formed in the trunk, the key cylinder being operable to lock and unlock the trunk, and a pad that is attached to the flange of the key cylinder and includes a hole through which the mounting bolt is inserted and a projection projecting toward a center of the key cylinder in the hole of the pad. When the mounting bolt is inserted into the mounting hole, the projection of the pad lies between the mounting bolt and the mounting hole.

The present application is based on Japanese patent application No. 2010-133010 filed on Jun. 10, 2010, the entire contents of which are incorporated herein by reference.

### BACKGROUND OF THE INVENTION

1. Field of the Invention

This invention relates to an installation structure for a key cylinder, in particular, an installation structure for a key cylinder in a vehicle.

2. Description of the Related Art

A latch part for maintaining a trunk door in an engaging state by engaging with a striker is fixed in a trunk of a rear part of a vehicle. For example, an outer handle is rotatably installed in a ceiling part of a mounting part of license plate, and the latch part can be operated by that the outer handle is operated from the outside. In addition, some vehicles have a structure that a key cylinder for locking and unlocking the trunk by a key operation is installed. For example, they have a structure that a key cylinder with an opener is fixed in a trunk located at the back of the vehicle together with a garnish part, and by operating the key cylinder, the striker engaged with the latch part can be unlocked from the outside, so that the trunk can be unlocked or locked (e.g., JP-A-2001-26220).

### SUMMARY OF THE INVENTION

However, although the structure shown in JP-A-2001-26220 that the key cylinder is installed in an approximately horizontal state to the trunk has a good workability in the installation work of the key cylinder, in case of a structure that the key cylinder is installed from a position located below the trunk of the vehicle, it is necessary that the installation work is carried out while the key cylinder and fixing bolts for fixing the key cylinder on a side of the vehicle are supported from a lower position at the installation of the key cylinder so as not to fall, thereby the workability may be lowered.

Therefore, it is an object of the invention to solve the above-mentioned problem and provide an installation structure for a key cylinder that has a good workability in the installation work of the key cylinder even if a structure that the key cylinder is installed from a position located below the trunk is adopted.

(1) According to one embodiment of the invention, a key cylinder installation structure comprises:

a key cylinder comprising a flange that is fixed to a trunk of a vehicle, the flange comprising a mounting hole through which a mounting bolt is inserted into a reference hole and a secondary reference hole, respectively, formed in the trunk, the key cylinder being operable to lock and unlock the trunk; and

a pad that is attached to the flange of the key cylinder and comprises a hole through which the mounting bolt is inserted and a projection projecting toward a center of the key cylinder in the hole of the pad,

wherein when the mounting bolt is inserted into the mounting hole, the projection of the pad lies between the mounting bolt and the mounting hole.

In the above embodiment (1) of the invention, the following modifications and changes can be made.

(i) The key cylinder is installed from below the trunk of the vehicle.

(ii) A lap margin of the projection of the pad lying between the mounting bolt on a side of the reference hole and the mounting hole of the flange is set to be more than a lap margin of the projection of the pad lying between the mounting bolt on a side of the secondary reference hole and the mounting hole of the flange.

(iii) The pad comprises an elastic material.

(iv) The pad is attached to the flange at an opposite side of the reference hole and the secondary reference hole.

(v) A distance between the mounting holes of the flange is greater than a distance between the reference hole and the secondary reference hole.

(vi) The projection on the side of the reference hole has a thickness more than that of the projection of on the side of the secondary reference hole.

Points of the Invention

According to one embodiment of the invention, a key cylinder installation structure is constructed such that a pad is mounted on a flange of a key cylinder, and upon the insertion of mounting bolts projections of the pad are bent to engage the mounting bolts with the projections of the pad. Thereby, the mounting bolts are unlikely to disengage or drop down, so that the workability in installing the key cylinder can be enhanced even when the key cylinder is installed from below, as in a trunk key cylinder.

### BRIEF DESCRIPTION OF THE DRAWINGS

The preferred embodiments according to the invention will be explained below referring to the drawings, wherein:

FIG. 1 is a perspective view schematically showing a trunk of a vehicle from behind to which an installation structure for a key cylinder according to one embodiment of the present invention is applied;

FIG. 2 is a cross-sectional view schematically showing a part of the installation structure for a key cylinder taken along the line A-A in FIG. 1;

FIG. 3A is a fragmentary plan view schematically showing a key cylinder 100 installed taken in the direction of the arrow B in FIG. 2;

FIG. 3B is a fragmentary plan view schematically showing a reinforcement 22 in which the key cylinder 100 is installed taken in the direction of the arrow B in FIG. 2;

FIG. 3C is a fragmentary plan view schematically showing the key cylinder 100 taken in the direction of the arrow B in FIG. 2;

FIG. 3D is a fragmentary plan view schematically showing a pad 300 taken in the direction of the arrow B in FIG. 2;

FIG. 4 is a cross-sectional view schematically showing a part of the installation structure for the key cylinder taken along the line C-C in FIGS. 2 and 3A;

FIG. 5A is a plan view schematically showing a pad;

FIG. 5B is a cross-sectional view taken along the line G-G in FIG. 5A;

FIG. 6A is a partial enlarged view of E part and F part in FIG. 4; and

FIG. 6B is a fragmentary plan view schematically showing each hole part taken in the direction of the arrow H in FIG. 6A.

### DETAILED DESCRIPTION OF THE PREFERRED EMBODIMENTS

### Embodiment

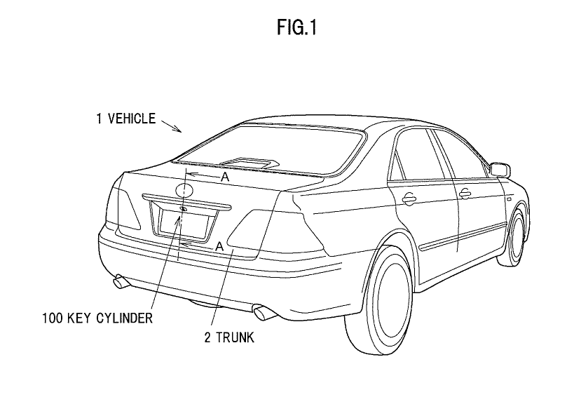

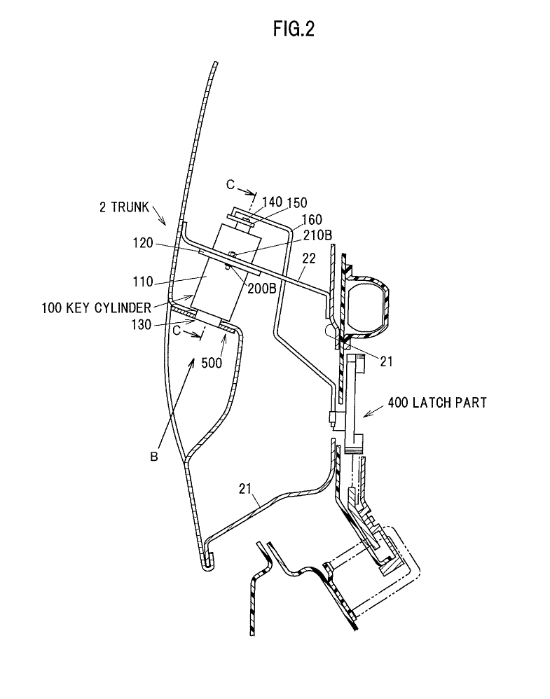

FIG. 1 is a perspective view schematically showing a trunk of a vehicle from behind to which an installation structure for a key cylinder according to one embodiment of the present invention is applied. FIG. 2 is a cross-sectional view schematically showing a part of the installation structure for a key cylinder taken along the line A-A in FIG. 1.

A key cylinder 100 to be installed in a trunk 2 of a vehicle 1 is fixed by that a flange 120 disposed in a cylinder case 110 of the key cylinder 100 is fastened to a reinforcement 22 welded to an inner panel 21 of the trunk 2 by using stud bolts 200A, 200B and nuts 210A, 210B. The key cylinder 100 is installed from a position (B in FIG. 2) located below the vehicle 1, therefore, as the operation of the key cylinder 100, a key is inserted into a key insertion port 130 from the lower position B and is rotated so that unlocking and the like of the trunk 2 is carried out.

(Structure of Key Cylinder 100)

The key cylinder 100 includes the cylinder case 110 as a housing part having the flange 120 for mounting and fixing the cylinder case 110 on a side of the vehicle 1, and a rotor unit (not shown) housed in the cylinder case 110 and rotatable by an insertion and rotation operation of a match key K that is a proper key.

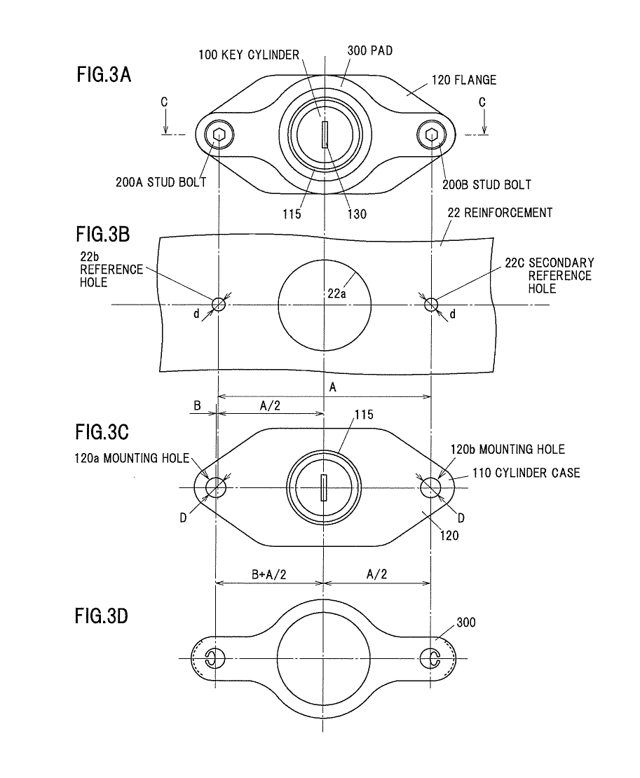

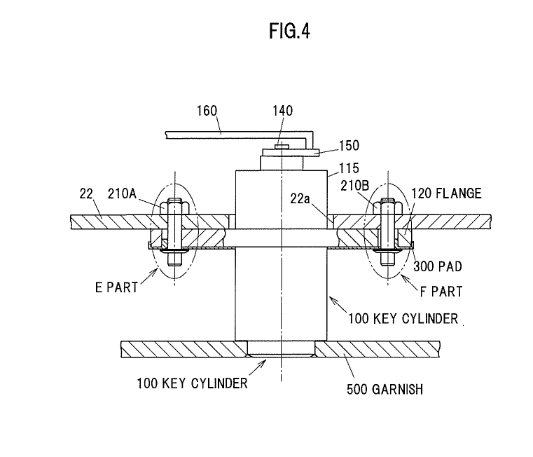

FIG. 3A is a fragmentary plan view schematically showing a key cylinder 100 installed taken in the direction of the arrow B in FIG. 2, FIG. 3B is a fragmentary plan view schematically showing a reinforcement 22 in which the key cylinder 100 is installed taken in the direction of the arrow B in FIG. 2, FIG. 3C is a fragmentary plan view schematically showing the key cylinder 100 taken in the direction of the arrow B in FIG. 2, and FIG. 3D is a fragmentary plan view schematically showing a pad 300 taken in the direction of the arrow B in FIG. 2. FIG. 4 is a cross-sectional view schematically showing a part of the installation structure for the key cylinder taken along the line C-C in FIGS. 2 and 3A.

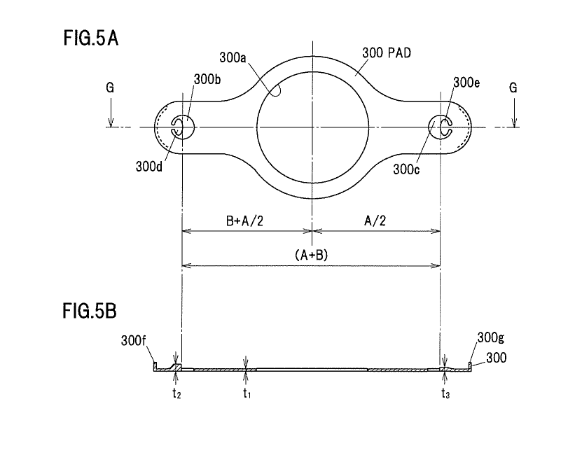

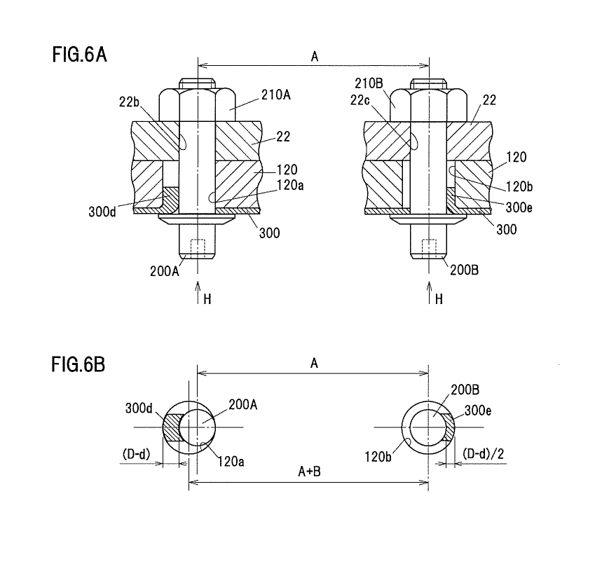

FIG. 5A is a plan view schematically showing a pad and FIG. 5B is a cross-sectional view taken along the line G-G in FIG. 5A. FIG. 6A is a partial enlarged view of E part and F part in FIG. 4 and FIG. 6B is a fragmentary plan view schematically showing each hole part taken in the direction of the arrow H in FIG. 6A. Hereinafter, based on the drawings, an installation structure for a key cylinder 100 will be explained.

As shown in FIG. 3B, in the reinforcement 22 in which the key cylinder 100 is mounted, a body hole part 22a that allows a body part 115 of the key cylinder 100 to pass through the body hole part 22a and to be housed therein, and a reference hole 22b and a secondary reference hole 22c that are corresponding to mounting holes formed in the flange 120 of the key cylinder 100.

The cylinder case 110 includes the body part 115 of a tubular shape having an interior space capable of housing the rotor unit, and the flange 120 extending from the body part 115 along the diameter direction. The flange 120 is fastened to the reinforcement 22 as a reinforcement member welded to the inner panel 21 of the trunk 2 by using stud bolts 200A, 200B and nuts 210A, 210B via the pad 300.

Tumbler fitting holes (not shown) that open to the inner periphery of the cylinder case 110 and communicate with the interior space are formed in the cylinder case 110, and by the insertion and rotation operation of the match key K, engagement between tumblers (not shown) and the cylinder case 110 is unlocked, thereby the rotor unit (not shown) becomes rotatable.

The key cylinder 100 has the key insertion port 130 through which the match key K can be inserted into and removed from the rotor unit (not shown), and is rotatably housed in the interior space of the cylinder case 110, and return characteristic is provided to the key cylinder 100 by springs (not shown) for returning the rotor. In addition, the key cylinder 100 is configured to have an operational function that the match key K is inserted into the key insertion port 130 and the rotor unit (not shown) is rotated, thereby the key cylinder 100 can be rotated from the initial position to a predetermined position so as to unlock the latch part 400.

As shown in FIG. 2, an operating rod 140 is mounted on the opposite side of the key insertion port 130 of the key cylinder 100, and the operating rod 140 is combined with a driving link 160 via a combining part 150. The driving link 160 is connected to the latch part 400. Due to the rotating operation of the key cylinder 100, the rotating motion of the operating rod 140 is transmitted by the driving link 160, thereby the unlocking operation of the latch part 400 is carried out.

As shown FIG. 3B, the reference hole 22b and the secondary reference hole 22c are formed in the reinforcement 22 so as to have a hole interval of “A” with a central focus on the body hole part 22a. In addition, both of the reference hole 22b and the secondary reference hole 22c are formed to have a diameter of “d”.

On the other hand, as shown FIG. 3C, mounting holes 120a, 120b are formed in the cylinder case 110, the mounting holes 120a, 120b being used for allowing that the stud bolts 200A, 200B pass through the flange 120 so as to be fastened to the reinforcement 22 by the nuts 210A, 210B. The mounting holes 120a, 120b are respectively formed so as to correspond to the reference hole 22b and the secondary reference hole 22c of the reinforcement 22.

Here, a distance from the center of the cylinder case 110 to the mounting hole 120a is set to B+A/2 and a distance from the center of the cylinder case 110 to the mounting hole 120b is set to A/2, and the hole interval between the mounting holes 120a, 120b is set to A+B. In addition, both of the mounting holes 120a, 120b are formed to have a diameter of “D”.

FIG. 3D is a fragmentary plan view schematically showing a pad 300 taken in the direction of the arrow B in FIG. 2. In addition, FIG. 5A is a plan view schematically showing a pad, and FIG. 5B is a cross-sectional view taken along the line G-G in FIG. 5A. The pad 300 is formed of, for example, a soft material having elasticity such as rubber. As shown in FIG. 4, the pad 300 is mounted from a side from which the stud bolts 200A, 200B are inserted into the flange 120 of the cylinder case 110.

As shown in FIG. 5A, the pad 300 is formed to have a shape corresponding to the flange 120 of the cylinder case 110 in a pan view, and a center hole 300a is formed in the center part, so as to allow the body part 115 to pass through the pad 300 and allow the pad 300 to be mounted in the cylinder case 110. The center hole 300a is formed to have a diameter larger than the body part 115.

In addition, hole parts 300b, 300c are formed so as to correspond to the mounting holes 120a, 120b formed in the flange 120 of the cylinder case 110 and so as to allow the stud bolts 200A, 200B to be inserted into and pass through the hole parts 300b, 300c. In the hole parts 300b, 300c, projections 300d, 300e are respectively formed so as to project from the edge portion of the hole parts 300b, 300c toward the center of the hole parts 300b, 300c.

As shown in FIG. 5B, the pad 300 is formed so as to have a basic thickness of t1, and the projection 300d is formed so as to have a thickness of t2. In addition, the projection 300e is formed so as to have a thickness of t3. In addition, hook parts 300f, 300g that are hooked by both end portions of the flange 120 are formed in the end portions of the pad 300 corresponding to both end portions of the flange 120.

Installation of the Key Cylinder

The installation of the key cylinder 100 in the vehicle 1 can be carried out by the following steps. The pad 300 is preliminarily mounted in the key cylinder 100. Namely, the key cylinder 100 is installed in a state that it can function as a key cylinder since the rotor unit (not shown) is mounted, and further, the pad 300 is mounted from a side from which the stud bolts 200A, 200B are inserted into the flange 120 of the cylinder case 110.

The is mounted in the flange 120 in a state that the center hole 300a allows the body part 115 of the cylinder case 110 to pass through, the hook parts 300f, 300g of both edge parts are hooked by both edge parts of the flange 120 and both of the pad 300 and the flange 120 come into approximately contact with each other in the each other's thickness direction.

In the above-mentioned state, an operator inserts the body part 115 of the key cylinder 100 into the body hole part 22a formed in the reinforcement 22 from the lower B position shown in FIG. 2. At this time, the mounting holes 120a, 120b of the flange 120 are roughly aligned so as to correspond to the reference hole 22b and the secondary reference hole 22c formed in the reinforcement 22.

In the state, the operator supports the key cylinder 100 from the low position. The stud bolt 200A is inserted into the mounting hole 120a of the flange 120 and the reference hole 22b formed in the reinforcement 22 from the lower position B shown in FIG. 2 so as to pass through the mounting hole 120a and the reference hole 22b. Similarly, the stud bolt 200B is inserted into the mounting hole 120b of the flange 120 and the secondary reference hole 22c formed in the reinforcement 22 so as to pass through the mounting hole 120b and the reference hole 22c. Relationships at the time between the stud bolt 200A and the projection 300d of the pad 300, and between the stud bolt 200B and the projection 300e of the pad 300 are shown in FIGS. 6A, 6B.

As shown in FIG. 6A, when the stud bolts 200A, 200B are inserted, the projections 300d, 300e of the pad 300 are bent toward the insertion direction according to the insertion of the stud bolts. Namely, a state shown in FIG. 6A is provided, the stud bolt 200A and the projection 300d of the pad 300 are engaged with each other, so that the stud bolt 200A does not easily drop out downward. Similarly, the stud bolt 200B and the projection 300e of the pad 300 are engaged with each other, so that the stud bolt 200B does not easily drop out downward.

Relationships between the stud bolts 200A, 200B and the projections 300d, 300e of the pad 300, and between the stud bolts 200A, 200B and the mounting holes 120a, 120b of the flange 120 become as shown in FIG. 6B. Since the pad 300 is formed of a material having elasticity such as rubber, when the projection 300d is fitted to a gap between the stud bolt 200A and the mounting hole 120a of the flange 120, as shown in FIG. 6B, the stud bolt 200A and an inner wall of the mounting hole 120a are brought into contact with each other. Here, if the thickness t2 of the projection 300d shown in FIG. 5B is set larger than a distance (D-d) of the gap between the stud bolt 200A and the mounting hole 120a of the flange 120 described above, the stud bolt 200A is pushed in the right direction in FIG. 6B. Thereby, the stud bolt 200A can be prevented from dropping out downward.

As described above, the thickness t2 of the projection 300d is set larger than the distance (D-d) of the gap, and further a dimensional relationship is set so as to meet the following. Here, the difference between the distance (D-d) of the gap and the thickness t2 of the projection 300d is an amount of compression within limit of elasticity, and is referred to as “lap margin (crush margin)”.

On a side of the reference hole 22b of the reinforcement 22 shown in FIGS. 6A, 6B, as shown in FIG. 6B, the lap margin is represented as t2-(D-d). On the other hand, on a side of the secondary reference hole 22c of the reinforcement 22, the lap margin is represented as t3-(D-d)/2. The lap margin of t2-(D-d) on a side of the reference hole 22b is set larger than the lap margin of t3-(D-d)/2 on a side of the secondary reference hole 22c, thereby the stud bolt 200A is pushed in the right direction in FIG. 6B, so that the stud bolt 200A and the inner wall of the mounting hole 120a are surely brought into contact with each other as shown in FIG. 6B. Thereby, the installing location of the key cylinder 100 at the installation work can be determined with good accuracy. For example, the lap margin of on a side of the reference hole 22b is set to 1 mm, and the lap margin on a side of the secondary reference hole 22c is set to 0.5 mm, and based on this, the pad 300 is fabricated, thereby the above-mentioned technical advantage can be obtained. Here, for example, if the thickness t1 of the pad 300 shown in FIG. 5B is set to 2 mm, the thickness t2 becomes 3 mm and t3 becomes 2.5 mm.

The stud bolts 200A, 200B are fastened by the nuts 210A, 210B in a state that the stud bolts 200A, 200B are inserted into and pass through the pad 300, the flange 120 and the reinforcement 22. Namely, as shown in FIG. 6A, the flange 120 and the reinforcement 22 are tightened together with each other so as to be fixed by the stud bolts 200A, 200B and the nuts 210A, 210B. At the time, the interval between the stud bolt 200A and the stud bolt 200B is “A” as shown in FIG. 6A, so that the installing location of the key cylinder 100 at the installation work can be determined with good accuracy regardless of the value of lap margin.

After the key cylinder 100 is installed on a side of the vehicle 1, as shown in FIGS. 2, 4, the garnish 500 is mounted, thereby a series of installation process is completed.

### ADVANTAGES OF THE EMBODIMENT

In accordance with an installation structure for a key cylinder according to the embodiment of the present invention, the following advantages are provided.

(1) The pad 300 is mounted in the flange 120 of the key cylinder 100, and the projects 300d, 300e of the pad 300 are bent by the insertion of the stud bolts 200A, 200B, thereby the stud bolts 200A, 200B and the projections 300d, 300e of the pad 300 are engaged with each other. Thereby, the stud bolt does not easily drop out downward, so that the workability of installation work can be enhanced even if the key cylinder 100 is installed from the lower position.
(2) The lap margin on a side of the reference hole 22b of the reinforcement 22 is set larger than the lap margin on a side of the secondary reference hole 22c, thereby the stud bolt 200A is pushed in the right direction in FIG. 6B, so that the stud bolt 200A and the inner wall of the mounting hole 120a are surely brought into contact with each other as shown in FIG. 6B. Thereby, the installing location of the key cylinder 100 at the installation work can be determined with good accuracy.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A key cylinder installation structure, comprising:
a key cylinder comprising a flange that is fixed to a trunk of a vehicle, the flange comprising a mounting hole through which a mounting bolt is inserted into a reference hole and a secondary reference hole, respectively, formed in the trunk, the key cylinder being operable to lock and unlock the trunk; and
a pad that is attached to the flange of the key cylinder and comprises a hole through which the mounting bolt is inserted and a projection projecting toward a center of the key cylinder in the hole of the pad,
wherein when the mounting bolt is inserted into the mounting hole, the projection of the pad lies between the mounting bolt and the mounting hole.

2. The key cylinder installation structure according to claim 1, wherein the key cylinder is installed from below the trunk of the vehicle.

3. The key cylinder installation structure according to claim 1, wherein a lap margin of the projection of the pad lying between the mounting bolt on a side of the reference hole and the mounting hole of the flange is set to be more than a lap margin of the projection of the pad lying between the mounting bolt on a side of the secondary reference hole and the mounting hole of the flange.

4. The key cylinder installation structure according to claim 1, wherein the pad comprises an elastic material.

5. The key cylinder installation structure according to claim 1, wherein the pad is attached to the flange at an opposite side of the reference hole and the secondary reference hole.

6. The key cylinder installation structure according to claim 1, wherein a distance between the mounting holes of the flange is greater than a distance between the reference hole and the secondary reference hole.

7. The key cylinder installation structure according to claim 3, wherein the projection on the side of the reference hole has a thickness more than that of the projection of on the side of the secondary reference hole.
